(19) United States
(12) Patent Application Publication
(10) Pub. No.: US 2013/0307927 A1
(43) Pub. Date: Nov. 21, 2013

(54) CONTENT RECEIVING DEVICE, DISPLAY DEVICE, AND METHOD THEREOF

(71) Applicant: SAMSUNG ELECTRONICS CO., LTD., Suwon-si (KR)

(72) Inventors: Hong-seok PARK, Anyang-si (KR); Jae-jun LEE, Suwon-si (KR); Yong-seok JANG, Hwaseong-si (KR); Hee-jean KIM, Yongin-si (KR); Yu-sung JOO, Yongin-si (KR)

(73) Assignee: SAMSUNG ELECTRONICS CO., LTD., Suwon-si (KR)

(21) Appl. No.: 13/887,930

(22) Filed: May 6, 2013

(30) Foreign Application Priority Data
May 16, 2012 (KR) 10-2012-0052192

(51) Int. Cl. H04N 5/06; H04N 13/00

(52) U.S. Cl. CPC H04N 5/06; H04N 13/0051
USPC 348/43; 348/521

(57) ABSTRACT

A display device is provided, which includes a first communication interface which receives a partial amount of contents of a plurality of contents which partial amount of contents have been synchronized with each other from a content receiving device, a second communication interface which receives a remaining amount of contents of the plurality of contents from a first communication network that is different from a second communication network from which the content receiving device receives the partial amount of contents, a signal processor which performs signal processing such that the partial amount of contents received via the first communication interface and the remaining amount of contents received via the second communication interface are displayable in synchronization with each other, and an output device which displays the plurality of signal-processed content.

### CROSS-REFERENCE TO RELATED APPLICATIONS

This application claims priority under 35 U.S.C. §119 from Korean Patent Application No. 10-2012-0052192, filed on May 16, 2012, in the Korean Intellectual Property Office, the disclosure of which is incorporated herein by reference in its entirety.

### BACKGROUND

1. Field

Exemplary embodiments relate to a content receiving device, a display device, and a method thereof, and more particularly to a content receiving device which receives a plurality of contents, a display device which displays the received plurality of contents, and a method thereof.

2. Description of the Related Art

With the development of electronic technology, various types of electronic devices have been developed and spread. In particular, various kinds of display devices, such as televisions (TVs), mobile phones, personal computers (PCs), notebook PCs, and personal digital assistants (PDAs), have been widely used, even at residential homes.

As the use of display devices has increased, user needs for display devices having diverse functions and high picture quality have been increased. Accordingly, various display systems, which can receive a specified signal, such as a set-top box and the like, or which can provide high-performance functions, such as content which exhibits high picture quality and high sound quality and three-dimensional (3D) content, have recently been developed.

In the related art, one content can typically be received via one transmission channel. Recently, because the content which exhibits the high picture quality and the high sound quality or the 3D content has a very large data size, or a combination of a plurality of contents is required in order to view one content, one transmission channel may be insufficient to receive the plurality of contents.

Accordingly, there has been a need for a technique for viewing content having a large data size in the case where such content is unable to be received via only one transmission channel.

### SUMMARY

Exemplary embodiments described herein address at least the above problems and/or disadvantages and provide at least the advantages described below. Accordingly, an aspect of one or more exemplary embodiments provides a content receiving device, a display device, and a method thereof, which can provide normal viewing of content to a viewer even in the case in which the content is unable to be normally received via one transmission channel.

According to one aspect of one or more exemplary embodiments, a display device connected to a content receiving device includes a first communication interface which receives a partial amount of contents of a plurality of contents which have been synchronized with each other from the content receiving device; a second communication interface which receives a remaining amount of contents of the plurality of contents from a first communication network that is different from a second communication network from which the content receiving device receives the partial amount of contents; a signal processor which performs signal processing such that the partial amount of contents received via the first communication interface and the remaining amount of contents received via the second communication interface are displayable in synchronization with each other; and an output device which displays the plurality of signal-processed contents.

In particular, the first communication interface may receive a decoded amount of contents of the partial amount of contents and first synchronization information, and the signal processor may decode the remaining amount of contents that is received via the second communication interface and synchronize the decoded amount of contents of the partial amount of contents and the decoded remaining amount of contents by using the received first synchronization information and second synchronization information included in the remaining amount of contents.

The received first synchronization information may be transferred by using an extended period of InfoFrame in accordance with HDMI communication standards, and may be transferred using at least one of an extended field of CEA-861 Auxiliary Video Information (AVI) InfoFrame, an InfoFrame in which an InfoFrame type reserved in CEA-861 is extended, and an extended field of HDMI Vendor Specific InfoFrame (VSI).

The plurality of contents may include at least one of a multi-angle content, a two-dimensional (2D) image and a depth image, a left-eye image and a right-eye image of three-dimensional (3D) content, a left-eye image and a right-eye image of 3D content and depth images thereof, and a plurality of divided Ultra High Definition (UHD) images.

According to another aspect of one or more exemplary embodiments, a content receiving device connected to a display device includes a first communication interface which receives a partial amount of contents of a plurality of contents which have been synchronized with each other; a signal processor which extracts synchronization information from the received partial amount of contents and which decodes the received partial amount of contents; and a second communication interface which transmits the decoded contents and the extracted synchronization information to the display device.

The synchronization information may be transferred by using an extended period of InfoFrame in accordance with HDMI communication standards, and may be transferred using at least one of an extended field of CEA-861 AVI InfoFrame, an InfoFrame in which an InfoFrame type reserved in CEA-861 is extended, and an extended field of HDMI VSI.

The content receiving device according to one or more exemplary embodiments may further include an output device which displays the decoded contents.

The plurality of contents may include at least one of a multi-angle content, a 2D image and a depth image, a left-eye image and a right-eye image of 3D content, a left-eye image and a right-eye image of 3D content and depth images thereof, or a plurality of divided UHD images.

According to still another aspect of one or more exemplary embodiments, a display method which is executable by using a display device connected to a content receiving device includes receiving a partial amount of contents of a plurality of contents which have been synchronized with each other from the content receiving device; receiving a remaining amount of contents of the plurality of contents from a first communication network that is different from a second communication network from which the content receiving device receives the partial amount of contents; performing signal processing such that the partial amount of contents received via a first communication interface and the remaining amount of contents received via a second communication interface are displayable in synchronization with each other; and displaying the plurality of signal-processed contents.

In particular, the receiving the partial amount of contents of the plurality of contents may include receiving a decoded amount of contents of the partial amount of contents and first synchronization information, and the performing the signal processing may include decoding the remaining amount of contents of the plurality of contents and synchronizing the decoded amount of contents of the partial amount of contents and the decoded remaining amount of contents by using the received first synchronization information and second synchronization information included in the remaining amount of contents.

The received first synchronization information may be transferred by using an extended period of InfoFrame in accordance with HDMI communication standards, and may be transferred using at least one of an extended field of CEA-861 AVI InfoFrame, an InfoFrame in which an InfoFrame type reserved in CEA-861 is extended, and an extended field of HDMI VSI.

The plurality of contents may include at least one of a multi-angle content, a 2D image and a depth image, a left-eye image and a right-eye image of 3D content, a left-eye image and a right-eye image of 3D content and depth images thereof, and a plurality of divided UHD images.

According to still another aspect of one or more exemplary embodiments, a content receiving method which is executable by using a content receiving device connected to a display device includes receiving a partial amount of contents of a plurality of contents which have been synchronized with each other; extracting synchronization information from the received partial amount of contents and decoding the received partial amount of contents; and transmitting the decoded contents and the extracted synchronization information to the display device.

The synchronization information may be transferred by using an extended period of InfoFrame in accordance with HDMI communication standards, and may be transferred using at least one of an extended field of CEA-861 AVI InfoFrame, an InfoFrame in which an InfoFrame type reserved in CEA-861 is extended, and an extended field of HDMI VSI.

The content receiving method according to one or more exemplary embodiments may further include displaying the decoded contents.

The plurality of contents may include at least one of a multi-angle content, a 2D image and a depth image, a left-eye image and a right-eye image of 3D content, a left-eye image and a right-eye image of 3D content and depth images thereof, and a plurality of divided UHD images.

According to still another aspect of one or more exemplary embodiments, a content receiving device connected to a display device includes a first communication interface which receives a plurality of contents which have been synchronized with each other, the plurality of contents being received from at least two different communication networks; a signal processor which encapsulates the plurality of received contents; and a second communication interface which transmits the plurality of encapsulated contents to the display device via one source address.

According to still another aspect of one or more exemplary embodiments, a display device connected to a content receiving device includes a communication interface which receives a plurality of contents, which plurality of contents has been encapsulated and transmitted via one source address, from the content receiving device; a signal processor which performs signal processing such that the plurality of received contents are displayable in synchronization with each other; and an output device which displays the plurality of signal-processed contents, wherein the plurality of signal-processed contents are synchronized with each other.

### BRIEF DESCRIPTION OF THE DRAWINGS

The above and other aspects, features and advantages of the exemplary embodiments will be more apparent from the following detailed description when taken in conjunction with the accompanying drawings, in which:

FIG. 1 is a schematic diagram which illustrates a display system according to an exemplary embodiment;

FIG. 2 is a block diagram which illustrates a configuration of a content receiving device according to an exemplary embodiment;

FIG. 3 is a block diagram which illustrates a detailed configuration of a signal processing unit according to an exemplary embodiment;

FIG. 4 is a block diagram which illustrates a configuration of a display device according to an exemplary embodiment;

FIG. 5 is a diagram which illustrates an operation of a display system according to an exemplary embodiment;

FIG. 6 is a diagram which illustrates an operation of a display system according to another exemplary embodiment;

FIG. 7 is a diagram which illustrates a structure of an image frame in accordance with HDMI standards according to an exemplary embodiment;

FIG. 8 is a diagram which illustrates a method for transmitting synchronization information according to an exemplary embodiment;

FIG. 9 is a diagram which illustrates a method for transmitting synchronization information according to another exemplary embodiment;

FIG. 10 is a diagram which illustrates a method for transmitting synchronization information according to still another exemplary embodiment;

FIG. 11 is a diagram which illustrates an operation of a display system according to still another exemplary embodiment;

FIG. 12 is a flowchart which illustrates a content receiving method according to an exemplary embodiment;

FIG. 13 is a flowchart which illustrates a display method according to an exemplary embodiment;

FIG. 14 is a diagram which illustrates a method for encapsulating and transmitting a plurality of contents according to an exemplary embodiment; and

FIG. 15 is a block diagram which illustrates a configuration of a content receiving device according to another exemplary embodiment.

### DETAILED DESCRIPTION OF EXEMPLARY EMBODIMENTS

Hereinafter, exemplary embodiments are described in detail with reference to the accompanying drawings.

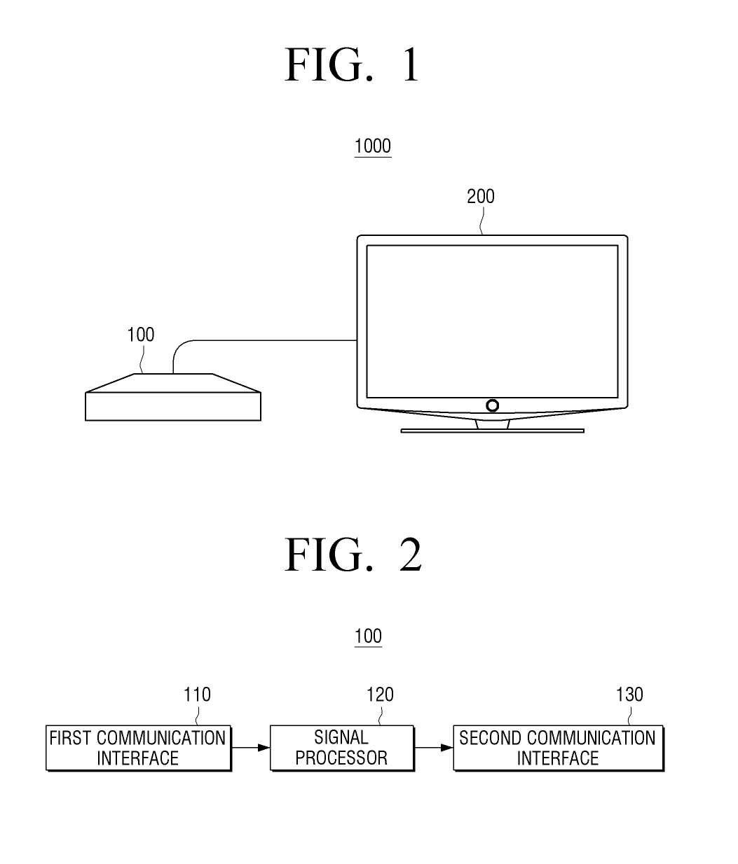

FIG. 1 is a schematic diagram which illustrates a display system according to an exemplary embodiment.

Referring to FIG. 1, a display system 1000 includes a content receiving device 100 and a display device 200.

The content receiving device 100 receives at least one content of a plurality of contents and provides the received content to the display device 200. The plurality of contents are contents that are displayed on the display device in synchronization with each other. The content receiving device 100 may receive at least one of the plurality of contents and transfer the received content to the display device 200, or may perform signal processing of the received content and transfer the signal-processed content to the display device 200.

The display device 200 may receive the content from the content receiving device 100, and selectively receive a remaining contents of the plurality of contents, which has not been received via the content receiving device, from a content providing device. In particular, if all of the contents to be displayed together in synchronization with each other are received via the content receiving device 100, the display device 200 does not receive the contents via a transmission channel, but receives all of the contents via the content receiving device 100. However, if the content receiving device 100 receives only a partial amount of contents of the plurality of contents, the display device 200 may receive the remaining amount of contents of the plurality of contents via the transmission channel.

The display device 200 may perform signal processing of the received contents of the plurality of contents, which has not been signal-processed, and display all the signal-processed contents together based on the synchronization information.

In particular, the plurality of contents may include at least one of a multi-angle content, a two-dimensional (2D) image and a depth image, a left-eye image and a right-eye image of three-dimensional (3D) content, a left-eye image and a right-eye image of 3D content and depth images thereof, and/or a plurality of divided Ultra High Definition (UHD) images.

Conversely, the content receiving device and the display device may communicate with each other via various interfaces. Specifically, one or more of analog type interfaces using a composite cable, a component cable, and a D-sub cable, or interfaces that can transmit digital data, such as High-Definition Multimedia Interface (HDMI), Digital Visual Interface (DVI), Universal Serial Bus (USB) Sony/Philips Digital Interface (S/PDIF), Multimedia over Coax Alliance (MoCA), and Digital Living Network Alliance (DLNA), may be used. Further, not only wire communication type interfaces but also various wireless communication-type interfaces that can transmit content may be used.

FIG. 2 is a block diagram which illustrates a configuration of a content receiving device according to an exemplary embodiment.

Referring to FIG. 2, the content receiving device 100 includes a first communication interface 110, a signal processor 120, and a second communication interface 130. In an exemplary embodiment, each of the first communication interface 110 and the second communication interface 130 includes one or more hardware and/or software components, such as, for example, a transmitter, a receiver, a transceiver, and/or software programs which implement functions relating to communication. The signal processor 120 includes one or more hardware and/or software components. For example, the signal processor 120 may include one or more of integrated circuitry, dedicated circuits, firmware, and or a processor which executes software programs for performing signal processing functions.

The first communication interface 110 receives at least one content of a plurality of contents that are displayed in synchronization with each other. Specifically, the first communication interface 110 receives content from a broadcasting station that transmits broadcasting program content in accordance with RF communication standards by using a broadcasting network and a web server that transmits content files by using the Internet.

In the case of receiving content from a broadcasting station, the first communication interface 110 may be implemented to include configurations, such as a tuner (not illustrated), a demodulator (not illustrated), and an equalizer (not illustrated). However, in the case of receiving content from a source such as a web server, the first communication interface 110 may be implemented by a network interface card (not illustrated).

In particular, the first communication interface 110 may include a plurality of communication interfaces which are used for receiving a plurality of contents. In the case where the plurality of contents are correlated contents or contents divided from one set of contents, such as, for example, a multi-angle content, a 2D image and a depth image, a left-eye image and a right-eye image of 3D content, a left-eye image and a right-eye image of 3D content and depth images thereof, or a plurality of divided UHD (Ultra High Definition) images, the plurality of first communication interfaces may receive the plurality of contents via different transmission channels. In order to transmit the plurality of contents, a bandwidth that is greater than double the frequency of the existing 2D content is required, and as the data size of the content itself is increased, the plurality of correlated contents or the plurality of divided contents may not be transmitted or received via only one transmission channel.

Conversely, in the case where the content receiving device 100 is provided with a plurality of first communication interfaces, it may not be necessary to receive the contents from the same types of sources, but a plurality of contents may be received from different types of sources which vary based on communication types. For example, left-eye image content of 3D content may be received by using an RF communication type, and right-eye image content may be received via the Internet.

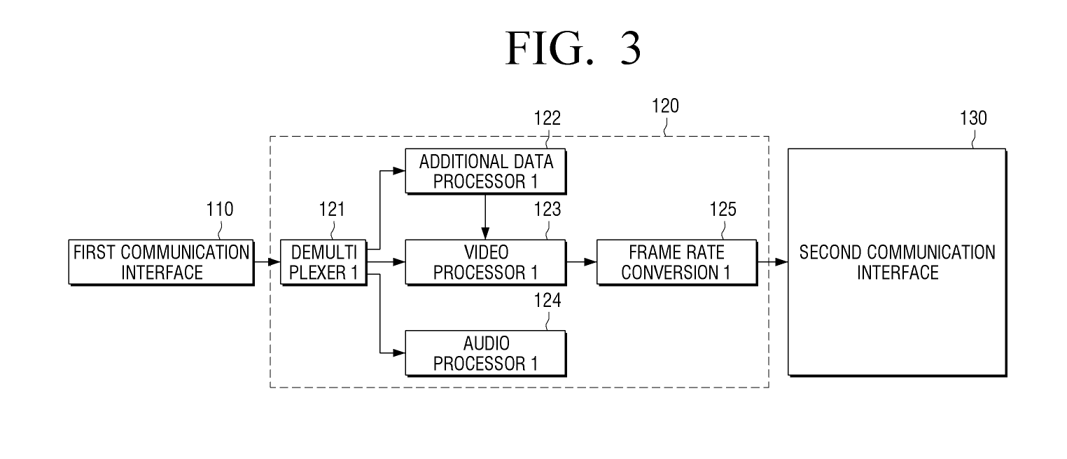

The signal processor 120 forms image frames as a result of processing the content received from the first communication interface. Referring to FIG. 3, the signal processor 120 will be described in more detail below.

FIG. 3 is a block diagram which illustrates a detailed configuration of a signal processor according to an exemplary embodiment.

Referring to FIG. 3, the signal processor 120 includes a demultiplexer 121, an additional data processor 122, a video processor 123, an audio processor 124, and a frame rate conversion component 125. Each of the demultiplexer 121, the additional data processor 122, the video processor 123, the audio processor 124, and the frame rate conversion component 125 may be implemented as a hardware component, such as, for example, integrated circuitry or a dedicated circuit or firmware, or as a software component, or as a processor which executes software to perform the respective function.

The demultiplexer 121 demultiplexes video data, audio data, and additional data included in the received contents and provides demultiplexed data to respective processing units. In particular, the demultiplexer 121 separates the video data, the audio data, and the additional data from the contents received from the first communication interface 110, and provides the separated data to the corresponding additional data processor, the video processor, and the audio processor, respectively.

The additional data processor 122, if the received contents include additional information, such as synchronization information, Electronic Program Guide (EPG) information, and/or caption information, may process the additional data separated by the demultiplexer 121 and add a processed caption or the like to the corresponding image frame. Conversely, the additional data such as a caption or the like may be separately received via the first communication interface 110 and be processed by the additional data processor 122.

Further, in order for the plurality of contents to be displayed on the display device in synchronization with each other, the synchronization information is required, and thus the additional data processor 122 may process the additional data such that the additional data can be received via the second communication interface 130.

The video processor 123 may generate image frames by performing the signal processing with respect to the video data separated by the demultiplexer 121. Specifically, the video processor 123 may include a decoder (not illustrated) that performs decoding with respect to the video data, and a scaler (not illustrated) that performs up or down-scaling to match the size of a screen onto which the video data is to be outputted.

In particular, in the case of signal-processing two or more contents, synchronized image frames may be generated by using the synchronization information included in the respective contents. Conversely, in the case where the second communication interface 130 uses an HDMI interface, frame-packing type image frames may be generated.

In addition, the video processor 123 may convert video data in a data format that corresponds to the frame rate conversion component 125. Specifically, in the case where the frame rate conversion component 125 processes the frames in a side-by-side format although the input video data is in a top-to-bottom format, the video processor 123 may convert the image frames of the respective content in the side-by-side format by connecting the image frames side by side in a horizontal direction.

The audio processor 124 performs signal processing with respect to audio data provided from the demultiplexer 121. Specifically, the audio processor 124 may include a decoder (not illustrated) that performs decoding with respect to the audio data, and a modulator (not illustrated) that modulates the respective decoded audio data into signals having different frequencies.

The frame rate conversion component 125 converts the frame rate of the contents provided from the video processor 123 to match a display rate with reference to an output rate of the display device 200. Specifically, if the display device 200 operates at 60 Hz, the frame rate conversion component 125 may convert the frame rate of the contents into 60 Hz.

In particular, in the case of receiving the contents via a plurality of first communication interfaces, a plurality of signal processors 120 may be configured. The plurality of signal processors may signal-process the plurality of contents received via the plurality of first communication interfaces. Further, in the case where a portion of the plurality of contents includes a depth image, the signal processor 120 may include a rendering unit (not illustrated) that performs rendering by using a general image and the depth image based on the synchronization information, and a synchronization unit (not illustrated) for synchronizing the plurality of contents.

Conversely, the content receiving device 100 may omit the operation of the signal processor 120. In particular, the content receiving device 100 may not include the signal processor 120, or may transmit the received contents in their current form to the display device 200 via the second communication interface 130 without signal-processing the received contents based on circumstances, although the content receiving device 120 includes the signal processor 120. If the signal processor 230 of the display device 200 has a prominent performance, it may be more efficient that the signal processor 230 of the display device 200 processes the content.

The second communication interface 130 transmits the content which has been signal-processed by the signal processor 120 to the display device 200. Specifically, the video data, the audio data, the synchronization information, and the additional data, having been processed by the signal processor, may be transmitted to the display device 200.

In particular, the second communication interface 130 may include one or more of a plurality of interfaces of various types. In the case where the second communication interface 130 transmits the contents that are received from the first communication interface 110 to the display device 200 without signal-processing the contents, the second communication interface 130 may convert the contents into a form that can be received by the display device and transfer the converted contents to the display device 200. For example, the second communication interface 130 may transfer the contents to the display device 200 via an HDMI or a coaxial cable.

For example, in the case where the first communication interface 110 receives RF type content and uses an HDMI, the second communication interface 130 may convert the received signal into an IP (Internet) communication-type signal and transfer the converted signal to the display device 200 via HDMI Ethernet and Audio Return Channel (HEAC) of the HDMI. Further, the second communication interface unit 130 may bypass the RF communication-type signal by using a coaxial cable, or convert the received signal into the IP communication-type signal and transfer the converted signal to the display device 200 in the case where a MoCA or DLNA output is possible. Based on circumstances, the contents may be transferred to the display device 200 via a combination of at least one of HDMI, RF bypass, MoCA, and DLNA. The MoCA is a technology which provides a home network service that transmits and distributes multimedia content and data via a coaxial cable that is pre-installed in the home in accordance with standards for a home entertainment network using a coaxial cable, and uses a channel having a 50 MHz bandwidth in a frequency band of 875 MHz to 1525 MHz. The DLNA refers to a technology which connects commercialized home electronic appliances in a home network by increasing the mutual compatibility of the home electronic appliances.

Conversely, in the case of signal-processing the contents received by the first communication interface 110 and transmitting the signal-processed contents to the display device 200, the second communication interface may transmit the contents to the display device 200 in an uncompressed state, and in particular, by using a data transmission interface that has not been signal-processed.

In the case of using the HDMI, the video data, the audio data, the synchronization information, and the additional data may be transmitted via a Transition Minimized Differential Signaling (TMDS) channel. Specifically, the synchronization information may be transmitted via a data island period. Conversely, the synchronization information may be transferred to the display device 200 via Consumer Electronics Control (CEC) of the HDMI and a HEAC. The CEC is a channel which is used for transmitting high-level control information between various video/audio appliances, and the HEAC is a communication channel that enables bidirectional data transmission based on the IEEE 802.3 Ethernet standard.

In an exemplary embodiment, the control receiving device 100 may further include an output device (not illustrated). The output device displays the contents that are signal-processed by the signal processor 120. For example, the content receiving device 100 may be implemented by various devices having an output device, such as, for example, a smart phone, a PDA, an MP3 player, a PDP, a notebook computer, and a tablet PC. The content receiving device 100 which includes the output device may directly output the signal-processed contents, in addition to the simple transfer of the received contents, to the display device 100.

For example, if the plurality of contents include multi-angle contents, the display device 200 may receive and display one or more first angle contents, and the content receiving device 100 may receive and display one or more second angle contents. Further, if the plurality of contents include 3D contents, the content receiving device 100 may receive and transfer one or more left-eye image contents to the display device 200 and display the left-eye image on a 2D screen, and the display device may receive both of the left-eye image contents and right-eye image contents and display the left-eye and right-eye image contents on a 3D screen. Further, the display device 200 may output Korean dubbed contents, and the content receiving device 100 may output English dubbed contents.

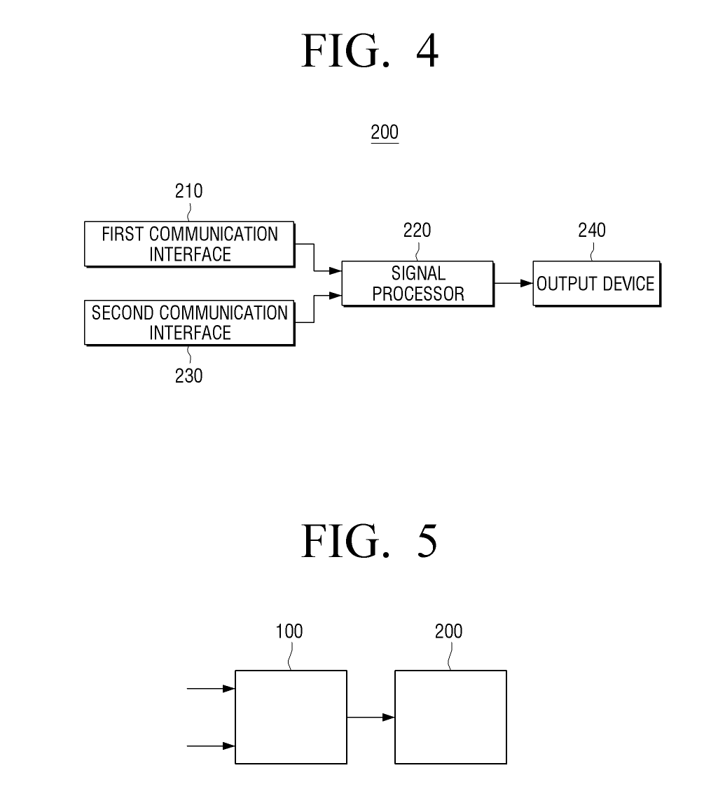

FIG. 4 is a block diagram which illustrates a configuration of a display device according to an exemplary embodiment.

Referring to FIG. 4, the display device 200 includes a first communication interface 210, a signal processor 220, a second communication interface 230, and an output device 240. The display device 200 may be implemented by various devices having a display, such as a TV, a mobile phone, a PDA, a notebook PC, a monitor, a tablet PC, an electronic book, a digital photo frame, and a kiosk.

The first communication interface 210 receives at least one content and a synchronization signal from the content receiving device. In particular, the content receiving device 100 may receive at least one content of the plurality of contents received by the control receiving device 100 and the synchronization signal. Based on circumstances, the received content may include content that has not been signal-processed or content that has been signal-processed.

Conversely, the first communication interface 210 is connected to a second communication interface 130 of the content receiving device 100. In particular, the first communication interface 210 of the display device 100 is a communication interface of the same type as the second communication interface 130 of the content receiving device 100.

The second communication interface 230 receives a remaining amount of contents of the plurality of contents which have been synchronized with each other. In particular, the second communication interface 230 receives the contents, which have not been received via the first communication interface 210, of the plurality of contents which have been synchronized with each other. In particular, the second communication interface 230 may receive the contents via a first communication network or a first transmission channel which is different from a second communication network or a second transmission channel from which the first communication interface 110 of the content receiving device 100 receives contents.

For example, if the first communication interface 110 of the content receiving device 100 receives the contents via an RF communication network, the second communication interface 230 of the display device 200 may receive the remaining contents via the Internet communication network. If the first communication interface 110 of the content receiving device 100 receives the contents via a first channel of the RF communication network, the second communication interface 230 may receive the contents via a second channel of the RF communication network.

Conversely, because the detailed configuration of the second communication interface 230 is similar to that of the first communication interface 110 of the content receiving device 100, the duplicate description thereof will be omitted. In the case where the content receiving device 100 receives all of the contents which have been synchronized with each other, the second communication interface 230 may be omitted.

The signal processor 220 performs signal processing with respect to the plurality of contents received via the first communication interface and the second communication interface. In particular, if the contents which have been received from the content receiving device 100 via the first communication interface 210 are the contents which have been signal-processed on the content receiving device 100, the signal processor 220 does not perform an additional signal processing procedure with respect to the signal-processed contents. However, the signal processor 220 synchronizes the signal-processed contents and the contents via the second communication interface by using a detection of the synchronization signal included in the signal-processed contents or using the synchronization signal separately received via the first communication interface. For this synchronization, the signal processor 220 may include a synchronization component (not illustrated). Further, in the case where a portion of the plurality of contents includes a depth image, the signal processor may include a rendering unit (not illustrated) that performs rendering by using a general image and the depth image based on the synchronization information.

In particular, because the detailed configuration of the signal processor 220 is similar to that of the signal processor 120 of the content receiving device 100, the duplicate description thereof will be omitted.

The output device 240 outputs the plurality of contents which have been synchronized with each other by the signal processor 220. In particular, the output device 240 can provide a corresponding image to a viewer by outputting image frames of the plurality of contents which have been synchronized with each other. Conversely, the output device may include a display (not illustrated) which outputs the image frames, and an audio output component (not illustrated) which outputs audio data in the case where the plurality of contents includes audio data.

Hereinafter, the operations of the content receiving device 100 and the display device 200 according to respective exemplary embodiments will be described in detail with reference to FIG. 5 and the following drawings.

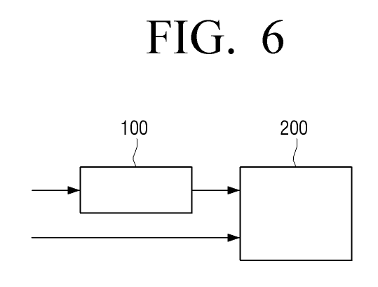

In FIGS. 5 and 6, for convenience in description, the content receiving device 100 and the display device 200 are connected to an outside via two lines. However, it should not be understood that FIGS. 5 and 6 refer to two transmission channels or two different communication networks, but instead, it should be noted that, based on circumstances, each line may correspond to a plurality of channels or a plurality of different communication networks.

FIG. 5 is a diagram which illustrates an operation of a display system according to an exemplary embodiment.

Referring to FIG. 5, the content receiving device 100 receives all of the contents which have been synchronized with each other. In particular, the content receiving device may receive the plurality of contents via different transmission channels or different communication networks.

In particular, the content receiving device 100 may signal-process and transmit all of the contents which have been synchronized with each other to the display device 200. Specifically, the content receiving device 100 may generate synchronized image frames by using the synchronization information included in the received contents, and transmit the image frames in an uncompressed state to the display device 200 by using an uncompressed data transmission interface. Further, in the case where the content receiving device 100 and the display device 200 are connected with each other via the HDMI, the content receiving device 100 may provide and transmit frame packing type frames to the display device 200.

Conversely, the display device 200 may receive the uncompressed image frames synchronized via the uncompressed data transmission interface and display the received image frames. Further, if a portion of the received contents includes the depth image, the display device 200 may generate and display stereoscopic 3D image frames by using a rendering procedure.

Referring to FIG. 5, the content receiving device 100 receives all of the contents which have been synchronized with each other. In particular, the content receiving device may receive the plurality of contents via different transmission channels or different communication networks.

Further, the content receiving device 100 may convert the compressed contents into a form that can be received by the display device 200 and transmit the converted contents to the display device 200 without signal-processing the plurality of received contents.

For example, in the case where the content receiving device 100 receives the RF type contents and uses the HDMI, the second communication interface unit 130 may convert the received contents into an IP (Internet) communication-type signal and transfer the converted contents to the display device 200 via the HEAC of the HDMI. Further, the content receiving device 100 may bypass the RF communication-type signal by using the coaxial cable, or convert the received signal into the IP communication-type signal and transfer the converted signal to the display device 200 in accordance with the MoCA or DLNA transmission standards in the case where the MoCA or DLNA output is possible. Based on circumstances, the content may be transferred to the display device 200 by using a combination of at least one of HDMI, RF bypass, and MoCA.

In particular, the content receiving device 100 may packetize the plurality of received contents in a single protocol form and transmits the content to the display device 200 via one IP source address.

Specifically, the content receiving device 100 may encapsulate the plurality of compressed contents received in a form that includes one program unit or a plurality of program units by performing parsing of the contents, and transmit the contents in a form of one transmission stream to the display device. Further, the content receiving device 100 may transmit the plurality of received contents to the display device by using a plurality of source addresses or by using one source address via a plurality of ports without encapsulating the contents.

FIG. 14 is a diagram which illustrates a method for encapsulating and transmitting a plurality of content according to an exemplary embodiment.

Referring to FIG. 14, it can be known that the transmission stream of the plurality of contents is encapsulated in one program section (illustrated as (a) in FIG. 14) or in a plurality of program sections (illustrated as (b) in FIG. 14) by an encapsulator 1410. As shown in (a) in FIG. 14, the transmission stream may be encapsulated to include one Program Association Table (PAT) 1420 and one Program Map Table (PMT) 1430. As shown in (b) in FIG. 14, the transmission stream may be encapsulated to have one PAT 1420 and a plurality of PMTs (Program Map Tables) 1430.

In particular, the encapsulator (not illustrated) may be configured to be included in the signal processor 120 of FIG. 3.

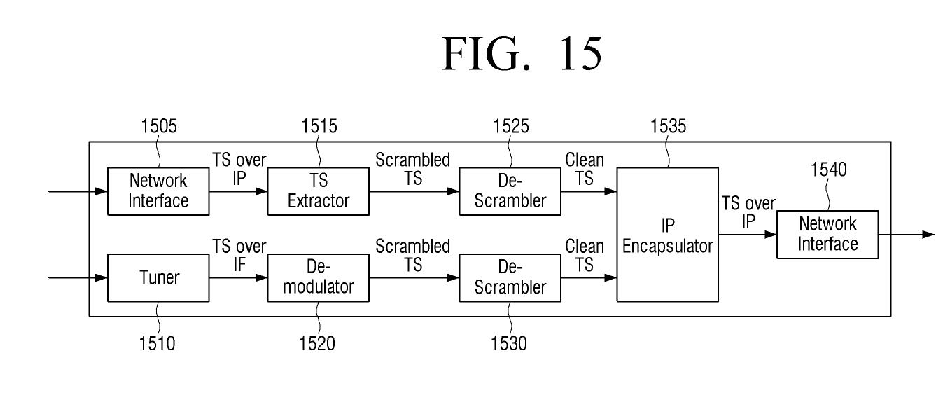

Conversely, in the case where the plurality of received contents have been scrambled, a descrambler which descrambles the contents received before the plurality of contents are encapsulated by the IP encapsulator may be further included. This will be described below in more detail with reference to FIG. 15.

FIG. 15 is a block diagram which illustrates a configuration of a content receiving device according to another exemplary embodiment.

Referring to FIG. 15, a network interface 1505 receives IP-type contents and a tuner 1510 receives RF-type contents. The received contents may be processed by a transmission stream (TS) extractor 1515 and a demodulator 1520, and then be forwarded to the respective descrambler 1525, 1530. The contents descrambled by the descrambler may be encapsulated by the IP encapsulator 1535, and then be transmitted to the display device 200 through the network interface 1540.

In particular, the network interface 1505 that receives the contents, the TS extractor 1515, the tuner 1510, and the demodulator 1520 may correspond to the first communication interface 110 in FIG. 3. Further, the descrambler 1525, 1530 and the IP encapsulator 1535 may correspond to the signal processor 120 in FIG. 3, and the network interface 1540 which receives an output from the IP encapsulator 1535 may correspond to the second communication interface in FIG. 3.

Although FIG. 15 shows that two IP-type and RF-type contents are received, the content transmission type and the number of content types are not limited. In particular, the plurality of contents in the IP and RF types may be received, respectively. Further, the descrambling procedure may be omitted with respect to the unscrambled content.

Conversely, the content receiving device 100 may packetize the plurality of received contents in a single protocol form and transmit the contents to the display device 200 via a plurality of IP source addresses. Further, the content receiving device 100 may transmit the plurality of contents by using different port numbers via one IP source address.

Even in this case, in the case where the plurality of received contents have been scrambled, a descrambler descrambling the contents received before the plurality of contents are encapsulated by the IP encapsulator may be further included.

Further, in the case of providing the contents in the IP type to the display device 200 via a network, the contents to be transmitted may be encrypted in an encryption form that a TV can understand. This prevents the situation that the encapsulated content leaks on the interface that is connected to the display device 200. Such encryption may be performed in the IP encapsulator.

The display device 200 may receive and signal-process the plurality of contents in the RF communication type or in the IP communication type. Conversely, the display device 200 may output respective image frames in synchronization with each other by using the synchronization information included in the respective contents, and if a portion of the plurality of received contents includes the depth image, the display device 200 may generate and display stereoscopic 3D image frames by using a rendering procedure.

FIG. 6 is a diagram which illustrates an operation of a display system according to another exemplary embodiment.

Referring to FIG. 6, the content receiving device 100 receives a partial amount of contents of the plurality of contents which have been synchronized with each other. In particular, if the received partial amount of contents are a plurality of contents, the content receiving device may receive the partial amount of contents via different transmission channels or via different communication networks.

The content receiving device 100 may signal-process and transmit all of the received partial amount of contents to the display device 200. Specifically, the content receiving device 100 may generate uncompressed image frames by signal-processing the received contents, include the synchronization information, which is included in the received contents, in the uncompressed image frame data, and transmit the uncompressed image frames and the synchronization information to the display device 200 by using the uncompressed data transmission interface.

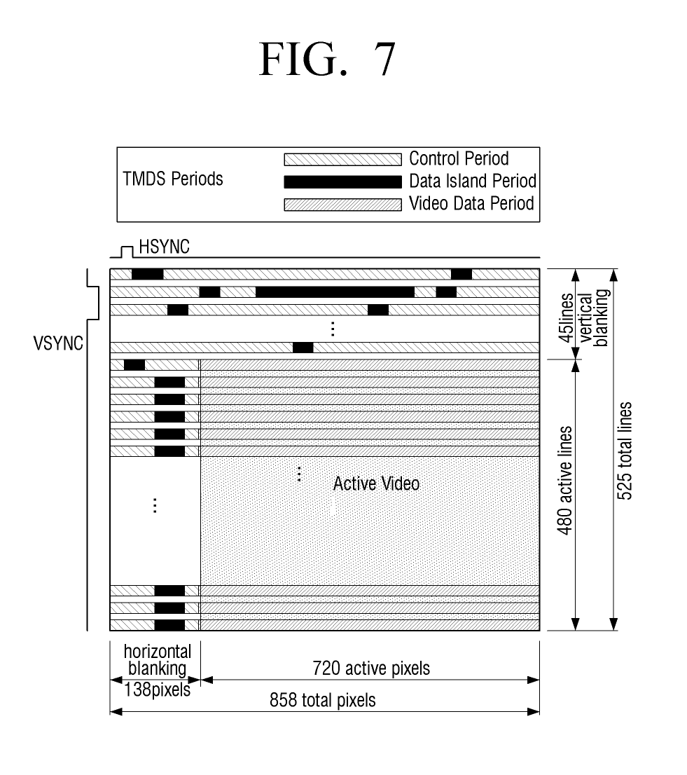

In particular, in the case where the content receiving device 100 and the display device 200 are connected via the HDMI, the content receiving device 100 may include the synchronization information in a data island period of the image frames and transmit the image frames to the display device 200. This will be described below in more detail with reference to FIG. 7.

FIG. 7 is a diagram which illustrates a structure of an image frame in accordance with HDMI standards according to an exemplary embodiment.

The image frame of FIG. 7 may be transmitted to the display device 200 via a TMDS channel of the HDMI. Referring to FIG. 7, the image frame in accordance with the HDMI standards includes a control period, a data island period, and a video data period. Among these periods, the video data period is a time interval during which video data included in the contents is included, and the data island period is a time interval during which audio data is included. In particular, the synchronization information may be included during the data island period within which the audio data is included.

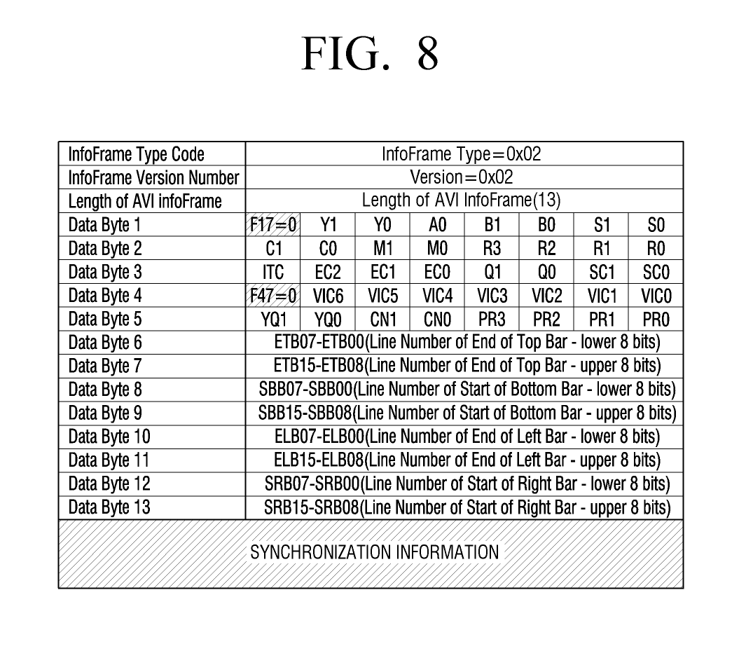

Further, an extended structure of InfoFrame may be used to transmit the synchronization information. This will be described below with reference to FIGS. 8, 9, and 10.

FIG. 8 is a diagram which illustrates a method for transmitting synchronization information according to an exemplary embodiment. Referring to FIG. 8, in order to transmit the synchronization information, an extended field of CEA-861 AVI InfoFrame may be used.

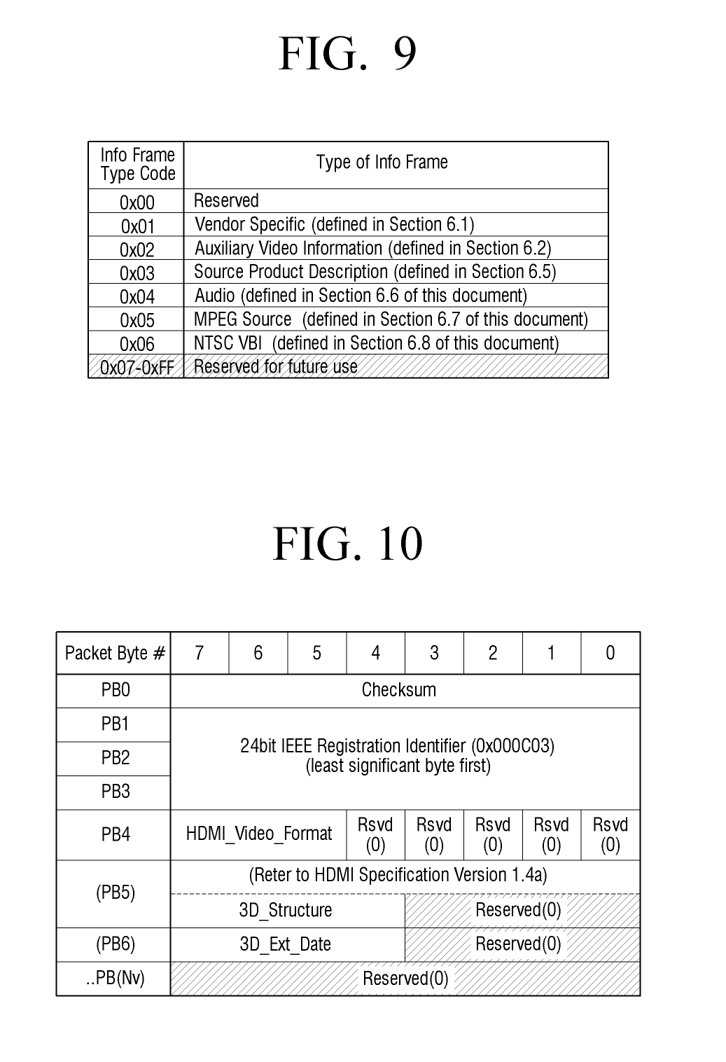

FIG. 9 is a diagram which illustrates a method for transmitting synchronization information according to another exemplary embodiment. Referring to FIG. 9, in order to transmit the synchronization information, an InfoFrame in which an InfoFrame type reserved in CEA-861 is extended may be used.

FIG. 10 is a diagram which illustrates a method for transmitting synchronization information according to still another exemplary embodiment. Referring to FIG. 10, in order to transmit the synchronization information, an extended field of HDMI VSI may be used.

Conversely, the display device 200 may receive signal-processed uncompressed contents in which the synchronization information is included from the content receiving device 100, receive the remaining contents of the plurality of contents from the communication network, and perform the signal processing thereof. In particular, the communication network via which the remaining contents of the plurality of contents are received may be different from the communication network via which the content receiving device 100 receives the partial amount of contents. Further, the display device 200 may receive the remaining contents of the plurality of contents via different transmission channels or via different communication networks.

The display device 200 may detect the synchronization information with respect to all of the received contents, and synchronize the respective image frames by using the detected synchronization information to output the synchronized image frames.

Further, according to another example, the display device 200 may extract the synchronization information included in the contents that are received from the communication network, request the contents having the synchronization information that coincides with the corresponding synchronization information from the content receiving device 100 in order to receive the requested contents, and synchronize and output the respective image frames. Specifically, in the case where the content receiving device 100 and the display device 200 are connected via the HDMI, the display device 200 may transfer a synchronization output signal to the display device 200 via the CEC or HEAC of the HDMI. The content receiving device 100 may transmit the corresponding contents to the display device based on the corresponding signal.

Further, if a portion of the plurality of received contents includes the depth image, the display device 200 may generate and display stereoscopic 3D image frames by using a rendering procedure.

Referring to FIG. 6, the content receiving device 100 receives a partial amount of contents of the plurality of contents which have been synchronized with each other. In particular, if the received partial amount of contents are a plurality of contents, the content receiving device may receive the partial amount of contents via different transmission channels or via different communication networks.

The content receiving device 100 may convert the compressed contents into a form that can be received by the display device 200 and transmit the converted contents to the display device 200 without signal-processing the partial amount of contents of the plurality of received contents.

Similarly to the embodiment in which the content receiving device 100 receives and transmits all of the contents to the display device without signal-processing the contents, the content receiving device may transfer the contents that are received via at least one of HDMI, RF bypass, MoCA, and DLNA to the display device 200. In particular, the content receiving device 100 may transmit the received contents in the RF or IP form to the display device 200.

In the case where one content is received as an example, if the IP-type content is received via the network, the IP-type content may be transmitted via a home network (e.g., MoCA and/or DLNA) or the HDMI in its present form, or may be converted into the RF type to be transmitted. Further, if the content is received via the RF, the content may be transmitted via an RF bypass or may be converted into the IP type to be transmitted via the network.

Conversely, the display device 200 may receive the contents that have not been signal-processed from the content receiving device 100, receive the remaining contents of the plurality of contents from the communication network, and perform the signal processing with respect to all of the contents. In particular, the communication network via which the remaining contents of the plurality of contents are received may be different from the communication network via which the content receiving device 100 receives the partial amount of contents. Further, the display device 200 may receive the remaining contents of the plurality of contents via different transmission channels or via different communication networks.

The display device 200 may detect the synchronization information included in the respective contents and synchronize the image frames of the respective contents based on the detected synchronization information to output the synchronized image frames. Further, if a portion of the plurality of received contents includes the depth image, the display device 200 may generate and display stereoscopic 3D image frames by using a rendering procedure.

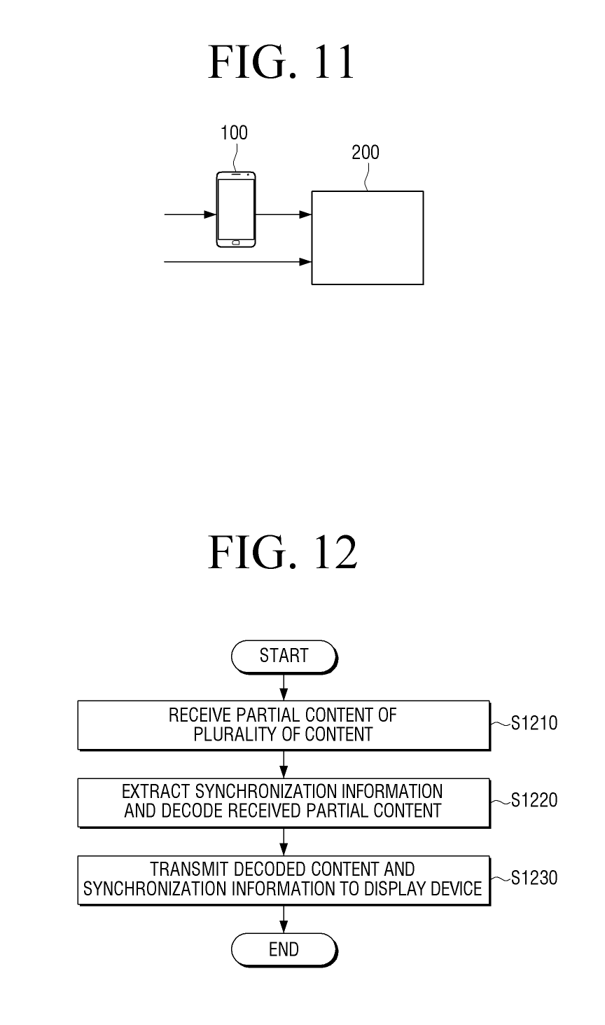

FIG. 11 is a diagram which illustrates an operation of a display system according to still another exemplary embodiment.

Referring to FIG. 11, the content receiving device 100 may be a mobile device. The content receiving device 100 may be implemented by various devices, such as, for example, at least one of a smart phone, a PDA, an MP3 player, a PDP, a notebook computer, and a tablet PC.

If the display device 200 has broadcasting schedule information such as EPG information, the content receiving device 100 may receive in advance a portion of the plurality of contents which have been synchronized with each other through reception of uniform resource name (URN) information relating to the contents that can be received in advance based on the broadcasting schedule information. Further, the content receiving device 100 may receive in advance the partial amount of contents of the plurality of contents by acquisition of the broadcasting schedule information.

In particular, if the content receiving device is a mobile device, the content receiving device may receive the contents via a wireless communication network such as wireless fidelity (Wifi), long term evolution (LTE), and 3G communication network, and may communicate with the display device by using at least one of various wireless communication techniques, such as, for example, Wifi, Bluetooth, Infrared Data Association (IRDA), RF (Radio Frequency), IEEE 802.11, wireless local area network (WLAN), high rate wireless personal area network (HR WPAN), ultra-wide band (UWB), low rate wireless personal area network (LR WPAN), and IEEE 1394.

The display device 200 may receive the remaining contents of the plurality of contents based on the broadcasting schedule, request a partial amount of contents of the plurality of contents received in advance from the content receiving device 100, and synchronize the plurality of contents to output the synchronized contents.

Conversely, if the content receiving device 100 is a mobile device having an output component, the content receiving device 100 may signal-process and display the received contents. For example, if the plurality of contents are 3D contents including a 2D image and a depth image, the content receiving device 100 may receive and output the 2D image and simultaneously transmit the received contents to the display device 200. Further, the display device 200 may receive the depth image from the communication network, receive the 2D image from the content receiving device 100, and perform synchronization and rendering of the images in order to output the images. Further, if the plurality of contents are multi-angle contents, the content receiving device may receive and display first angle contents and the display device may receive and display second angle contents.

Hereinafter, a content receiving method and a display method according to an exemplary embodiment will be described. Because the exemplary embodiments in relation to the content receiving device and the display device have been described in detail, duplicate portions will be omitted, and the description thereof will be made simply.

FIG. 12 is a flowchart which illustrates a content receiving method according to an exemplary embodiment.

Referring to FIG. 12, in operation S1210, a partial amount of contents of a plurality of contents is received. The plurality of contents are contents which have been synchronized with each other, and the content receiving device may receive the partial amount of contents of the plurality of synchronized contents. Then, in operation S1220, synchronization information included in the received contents is extracted, and the received partial amount of contents is decoded. In particular, with respect to the received contents, not only the decoding procedure but also the above-described signal processing procedure for generating image frames can be performed. Thereafter, in operation S1230, the decoded contents and the synchronization information are transmitted to the display device.

In particular, the synchronization information may be transferred by using InfoFrame in accordance with the HDMI communication standards. The content receiving method may further include displaying the decoded contents. The plurality of contents may include at least one of a multi-angle content, a 2D image and a depth image, a left-eye image and a right-eye image of 3D content, a left-eye image and a right-eye image of 3D content and depth images thereof, or a plurality of divided UHD (Ultra High Definition) images.

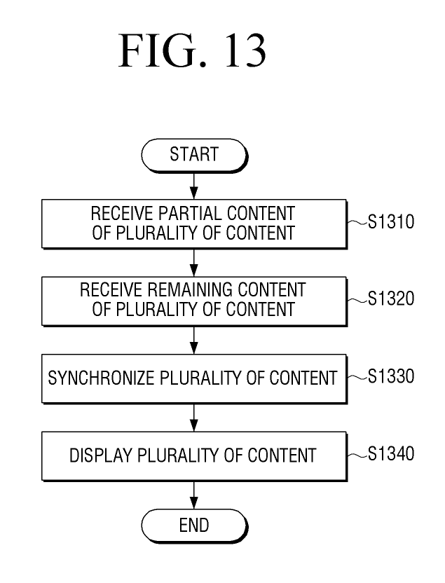

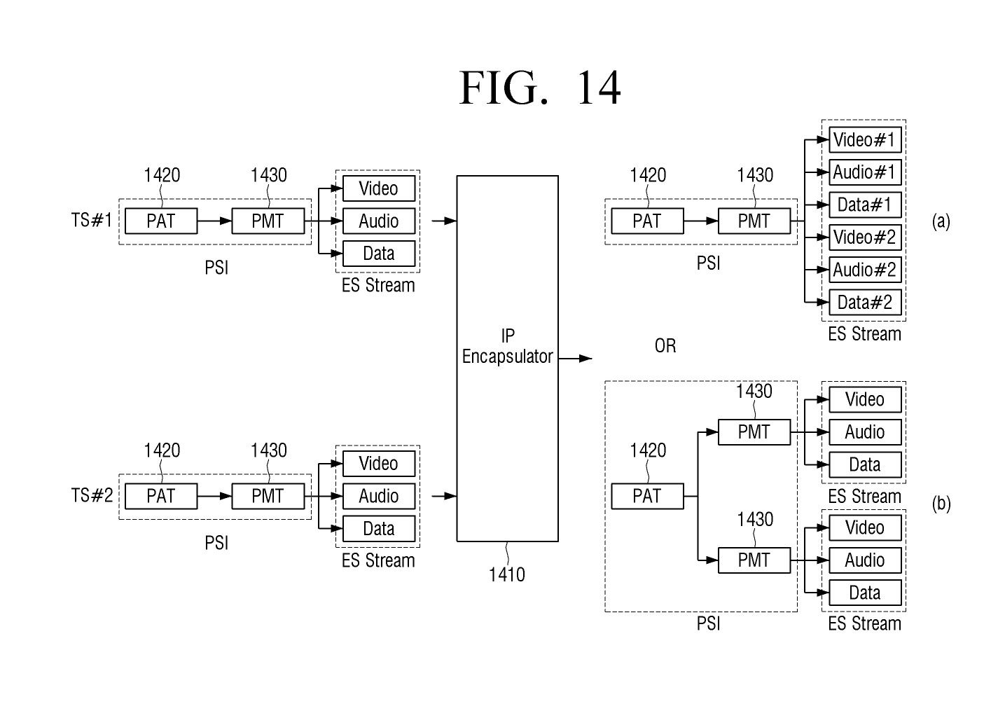

FIG. 13 is a flowchart which illustrates a display method according to an exemplary embodiment.

Referring to FIG. 13, in operation S1310, a partial amount of contents of a plurality of contents is received. Specifically, the partial amount of contents of the plurality of contents which have been synchronized with each other is received from the content receiving device. In particular, the operation S1310 of receiving the partial amount of contents may include receiving the decoded partial amount of contents and the synchronization information. Then, in operation S1320, the remaining amount of contents of the plurality of contents is received. In particular, the remaining amount of contents of the plurality of contents may be received via a communication network that is different from the communication network that is provided for the content receiving device.

Then, in operation S1330, the plurality of contents that include the received partial amount of contents and the remaining amount of contents are synchronized. In particular, the synchronization operation S1330 may include decoding the remaining amount of contents of the plurality of contents, and synchronizing the plurality of contents by using the synchronization information relating to the received partial amount of contents and the synchronization information included in the remaining amount of contents. Lastly, in operation S1340, the plurality of synchronized contents are displayed.

In particular, the synchronization information may be transferred by using the extended period of InfoFrame in accordance with the HDMI communication standards. More specifically, the synchronization information may be transferred by using at least one of an extended field of CEA-861 AVI InfoFrame, an InfoFrame in which an InfoFrame type reserved in CEA-861 is extended, and an extended field of HDMI VSI.

Further, the plurality of contents may include at least one of a multi-angle content, a 2D image and a depth image, a left-eye image and a right-eye image of 3D content, a left-eye image and a right-eye image of 3D content and depth images thereof, or a plurality of divided UHD images.

While the present disclosure has been shown and described with reference to certain exemplary embodiments thereof, it will be understood by those skilled in the art that various changes in form and detail may be made therein without departing from the spirit and scope of the present disclosure, as defined by the appended claims.

What is claimed is:

1. A display device connected to a content receiving device, comprising:
a first communication interface which receives a partial amount of contents of a plurality of contents which have been synchronized with each other from the content receiving device;
a second communication interface which receives a remaining amount of contents of the plurality of contents from a first communication network that is different from a second communication network from which the content receiving device receives the partial amount of contents;
a signal processor which performs signal processing such that the partial amount of contents received via the first communication interface and the remaining amount of contents received via the second communication interface are displayable in synchronization with each other; and
an output device which displays the plurality of signal-processed contents.

2. The display device as claimed in claim 1, wherein the first communication interface receives a decoded amount of contents of the partial amount of contents and first synchronization information, and
the signal processor decodes the remaining amount of contents that is received via the second communication interface and synchronizes the decoded amount of contents of the partial amount of contents and the decoded remaining amount of contents by using the received first synchronization information and second synchronization information included in the remaining amount of contents.

3. The display device as claimed in claim 2, wherein the received first synchronization information is transferred by using an extended period of InfoFrame in accordance with HDMI communication standards.

4. The display device as claimed in claim 3, wherein the received first synchronization information is transferred by using at least one of an extended field of CEA-861 Auxiliary Video Information (AVI) InfoFrame, an InfoFrame in which an InfoFrame type reserved in CEA-861 is extended, and an extended field of HDMI Vendor Specific InfoFrame (VSI).

5. The display device as claimed in claim 1, wherein the plurality of contents includes at least one of a multi-angle content, a two-dimensional (2D) image and a depth image, a left-eye image and a right-eye image of three-dimensional (3D) content, a left-eye image and a right-eye image of 3D content and depth images thereof, and a plurality of divided Ultra High Definition (UHD) images.

6. A content receiving device connected to a display device, comprising:
a first communication interface which receives a partial amount of contents of a plurality of contents which have been synchronized with each other;
a signal processor which extracts synchronization information from the received partial amount of contents and which decodes the received partial amount of contents; and
a second communication interface which transmits the decoded contents and the extracted synchronization information to the display device.

7. The content receiving device as claimed in claim 6, wherein the synchronization information is transferred by using an extended period of InfoFrame in accordance with HDMI communication standards.

8. The content receiving device as claimed in claim 7, wherein the synchronization information is transferred by using at least one of an extended field of CEA-861 Auxiliary Video Information (AVI) InfoFrame, an InfoFrame in which an InfoFrame type reserved in CEA-861 is extended, and an extended field of HDMI Vendor Specific InfoFrame (VSI).

9. The content receiving device as claimed in claim 6, further comprising an output device which displays the decoded contents.

10. The content receiving device as claimed in claim 6, wherein the plurality of contents includes at least one of a multi-angle content, a two-dimensional (2D) image and a depth image, a left-eye image and a right-eye image of three-dimensional (3D) content, a left-eye image and a right-eye image of 3D content and depth images thereof, and a plurality of divided Ultra High Definition (UHD) images.

11. A display method which is executable by using a display device connected to a content receiving device, comprising:
receiving a partial amount of contents of a plurality of contents which have been synchronized with each other from the content receiving device;
receiving a remaining amount of contents of the plurality of contents from a first communication network that is different from a second communication network from which the content receiving device receives the partial amount of contents;
performing signal processing such that the partial amount of contents received via a first communication interface and the remaining amount of contents received via a second communication interface are displayable in synchronization with each other; and
displaying the plurality of signal-processed contents.

12. The display method as claimed in claim 11, wherein the receiving the partial amount of contents of the plurality of contents includes receiving a decoded amount of contents of the partial amount of contents and first synchronization information, and
the performing the signal processing includes decoding the remaining amount of contents of the plurality of contents and synchronizing the decoded amount of contents of the partial amount of contents and the decoded remaining amount of contents by using the received first synchronization information and second synchronization information included in the remaining amount of contents.

13. The display method as claimed in claim 12, wherein the received first synchronization information is transferred by using an extended period of InfoFrame in accordance with HDMI communication standards.

14. The display method as claimed in claim 13, wherein the received first synchronization information is transferred by using at least one of an extended field of CEA-861 Auxiliary Video Information (AVI) InfoFrame, an InfoFrame in which an InfoFrame type reserved in CEA-861 is extended, and an extended field of HDMI Vendor Specific InfoFrame (VSI).

15. The display method as claimed in claim 11, wherein the plurality of contents includes at least one of a multi-angle content, a two-dimensional (2D) image and a depth image, a left-eye image and a right-eye image of three-dimensional (3D) content, a left-eye image and a right-eye image of 3D content and depth images thereof, and a plurality of divided Ultra High Definition (UHD) images.

16. A content receiving method which is executable by using a content receiving device connected to a display device, comprising:
receiving a partial amount of contents of a plurality of contents which have been synchronized with each other;
extracting synchronization information from the received partial amount of contents and decoding the received partial amount of contents; and
transmitting the decoded contents and the extracted synchronization information to the display device.

17. The content receiving method as claimed in claim 16, wherein the synchronization information is transferred by using an extended period of InfoFrame in accordance with HDMI communication standards.

18. The content receiving method as claimed in claim 17, wherein the synchronization information is transferred by using at least one of an extended field of CEA-861 Auxiliary Video Information (AVI) InfoFrame, an InfoFrame in which an InfoFrame type reserved in CEA-861 is extended, and an extended field of HDMI Vendor Specific InfoFrame (VSI).

19. The content receiving method as claimed in claim 16, further comprising displaying the decoded contents.

20. The content receiving method as claimed in claim 16, wherein the plurality of contents includes at least one of a multi-angle content, a two-dimensional (2D) image and a depth image, a left-eye image and a right-eye image of three-dimensional (3D) content, a left-eye image and a right-eye image of 3D content and depth images thereof, and a plurality of divided Ultra High Definition (UHD) images.

21. A content receiving device connected to a display device, comprising:
a first communication interface which receives a plurality of contents which have been synchronized with each other, the plurality of contents being received from at least two different communication networks;
a signal processor which encapsulates the plurality of received contents; and
a second communication interface which transmits the plurality of encapsulated contents to the display device via one source address.

22. A display device connected to a content receiving device, comprising:
a communication interface which receives a plurality of contents, which plurality of contents has been encapsulated and transmitted via one source address, from the content receiving device;
a signal processor which performs signal processing such that the plurality of received contents are displayable in synchronization with each other; and
an output device which displays the plurality of signal-processed contents, wherein the plurality of signal-processed contents are synchronized with each other.
